(19) United States
(12) Patent Application Publication
(10) Pub. No.: US 2007/0059973 A1
(43) Pub. Date: Mar. 15, 2007

(54) HOT PLUG WIRE CONTACT AND CONNECTOR ASSEMBLY

(75) Inventors: David James Fabian, Mount Joy, PA (US); John Michael Landis, Camp Hill, PA (US); Christopher G. Daily, Harrisburg, PA (US); Timothy Lee Kocher, Camp Hill, PA (US)

Correspondence Address: Helen Odar Wolstoncroft;Tyco Electronic, Suite 140, 4550 New Linden Hill Road, Wilmington, DE, 19808-2952, US

(73) Assignee: Tyco Electronics Corporation

(21) Appl. No.: 11/227,602

(22) Filed: Sep. 15, 2005

(51) Int. Cl. H01R 13/58

(52) U.S. Cl. 439/475

(57) ABSTRACT

An electrical connector and contact includes a contact body having an axial length, a termination section extending from the body, a first primary contact beam extending from the body and spaced from the body by a first axial length, and a sacrificial leading contact beam extending from the body for a second axial length. The second length is greater than the first length, and a distal end of the contact beam is configured to complete or break an energized electrical connection with a mating contact.

### BACKGROUND OF THE INVENTION

This invention relates generally to electrical connectors, and, more particularly, to separable electrical connectors operable under energized electrical load current conditions.

In certain installations, such as interconnection of lighting ballasts for fluorescent lights, it is desirable to connect or disconnect lighting ballasts in an energized electrical system. Ballasts may therefore be connected or disconnected to the electrical system by plugging and unplugging electrical connectors without having to de-energize or shut down some or all of the electrical system. Thus, with convenient plug connectors, a lighting system may be safely and more easily replaced when lighting requirements change. Thus, for example, lighting ballasts may be added or removed to an existing lighting system with plug-in connection. Connecting and breaking load currents in such a system, however, presents a number of challenges.

For example, making and breaking of the electrical connection under load conditions may result in intense energy discharges within the connector system as the connector contacts are engaged and disengaged. For example, known lighting systems may operate at voltages of 277 V to 600 V, and may experience currents of 1-5 A in normal operation Most commercially available connectors are not suited for completing and breaking such connections under load. In particular, energy discharge as electrical connections are completed and broken in such load conditions may damage the electrical contacts of the connectors and prevent them from being properly engaged or disengaged. Especially when such connectors are repeatedly used to connect or disconnect the electrical connection, damage to the electrical contacts is a primary concern.

Additionally, electricians, maintenance personnel or homeowners using the connector system must be protected from the energy associated with completing and breaking an energized electrical connection. Electricians, maintenance personnel or homeowners must also be protected from inadvertent contact with energized portions of the connector assembly in an unplugged condition.

Most commercially known connectors are incapable of providing safe and reliable connection and disconnection under energized circuit conditions while meeting other considerations such as ease of wire termination and low cost.

### BRIEF DESCRIPTION OF THE INVENTION

In an exemplary embodiment, an electrical contact is provided. The contact includes a contact body having an axial length, a termination section extending from the body, a primary contact area extending from the body and spaced from the body by a first axial length, and a sacrificial leading contact beam extending from the body for a second axial length. The second length is greater than the first length, and a distal end of the contact beam is configured to complete or break an energized electrical connection with a mating contact.

In another embodiment, a connector assembly comprises a first connector comprising a housing and a first contact therein, and a second connector matable with the first connector. The second connector includes a housing and a second contact therein. The first contact comprises a wire termination section, a primary contact area spaced from the wire termination section, and a leading contact beam spaced from the primary contact area. The second contact establishes electrical connection with the leading contact beam before establishing electrical connection with the primary contact area when the connectors are mated. In one embodiment, the wire termination section is a poke-in contact section.

In yet another embodiment, a connector assembly comprises a first connector comprising a housing and a first contact therein. The first contact includes a wire termination section, a pair of primary contact beams and a leading contact beam configured to complete and break an energized electrical connection. A second connector is matable with the first connector in plugged and unplugged positions. The second connector comprises a housing and a second contact having a contact blade therein. When the first and second connectors are mated, the contact blade establishes electrical connection with the leading contact beam at an end thereof and at a location spaced from the pair of primary contact beams before being received by and establishing electrical connection with the pair of primary contact beams.

### BRIEF DESCRIPTION OF THE DRAWINGS

FIG. 1 is a perspective view of a first embodiment of an exemplary connector assembly in an unplugged or unmated position.

FIG. 2 is an exploded view of a male connector for the assembly shown in FIG. 1.

FIG. 3 is an exploded view of a female connector for the assembly shown in FIG. 1.

FIG. 4 is an enlarged view of the contacts of the female connector shown in FIG. 3.

FIG. 5 is a sectional view of the assembly shown in FIG. 1 in a plugged or mated position.

FIG. 6 is a perspective view of a second embodiment of an exemplary connector assembly in an unplugged or unmated position.

FIG. 7 is a sectional view of the assembly shown in FIG. 6 in a plugged or mated position.

FIG. 8 is a perspective view of a second embodiment of an exemplary connector assembly in an unplugged or unmated position.

FIG. 9 is an exploded view of a male connector for the assembly shown in FIG. 8.

FIG. 10 is a partial exploded view of a female connector for the assembly shown in FIG. 8.

FIG. 11 is a sectional view of the assembly shown in FIG. 8 in a plugged or mated position.

FIG. 12 is a perspective view of electrical contacts for the assembly shown in FIG. 8 in a mated position.

FIG. 13 is a perspective view of another embodiment of a male connector for a hot pluggable connector system.

FIG. 14 is an exploded view of the connector shown in FIG. 13.

FIG. 15 is a perspective view of an exemplary contact for the connector shown in FIGS. 13 and 14.

FIG. 16 is a perspective view of another embodiment of a female connector for use with the male connector shown in FIGS. 13 and 14.

FIG. 17 is an exploded view of the connector shown in FIG. 16.

FIG. 18 is a perspective view of an exemplary contact for the connector shown in FIGS. 16 and 17.

FIG. 19 is a perspective view of an alternative contact for the connector shown in FIGS. 16 and 17.

FIG. 20 is a perspective view of an alternative contact for the connector shown in FIG. 3.

FIG. 21 is a perspective view of another alternative contact for the connector shown in FIG. 3.

FIG. 22 is a cutaway view of another embodiment of a hot pluggable connector assembly.

FIG. 23 is a perspective view of an alternative contact for the assembly shown in FIG. 22.

FIG. 24 illustrates the contact in FIG. 23 terminated to a wire.

### DETAILED DESCRIPTION OF THE INVENTION

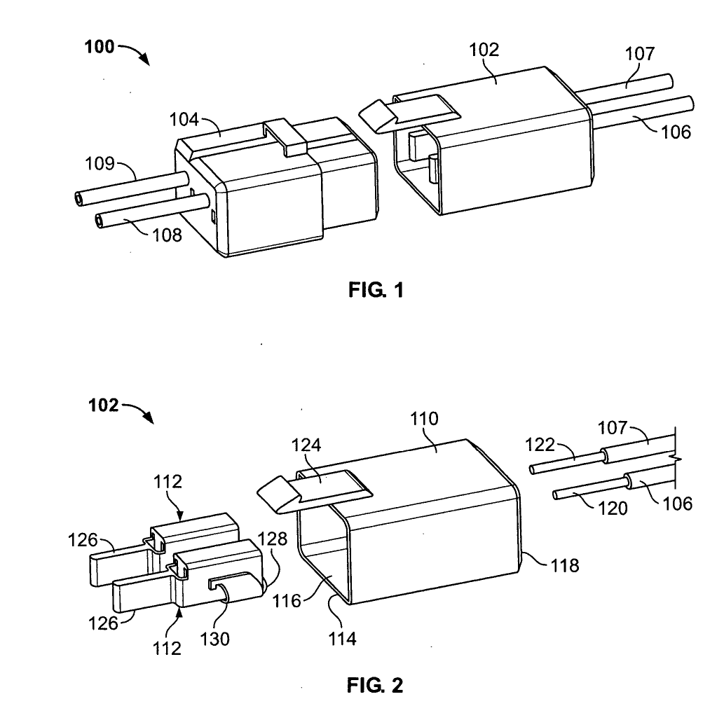

FIG. 1 is a perspective view of a first embodiment of an exemplary connector assembly 100 formed in accordance with an exemplary embodiment of the invention and arranged in an unplugged or unmated condition. The connector assembly 100 includes a male connector 102 and a female connector 104 interconnecting first and second load wires 106, 107 with respective first and second line wires 108, 109.

As explained below, the connector assembly 100 permits connection of the load wires 106, 107 and the line wires 108, 109 that requires minimal time and effort to complete. Moreover, the connectors may be engaged and disengaged to reliably complete and break electrical interconnection of the wires 106, 107 and 108, 109 while the wires are energized and still under electrical load. That is, the connector assembly 100 is operable without de-energizing the associated circuitry, sometimes referred to herein as “hot plugging.”

FIG. 2 is an exploded view of the male connector 102 including a housing 110 fabricated from a nonconductive or dielectric material, contacts 112 loadable into the housing 110, and connecting load wires 106, 107. The housing 110 is generally rectangular in an exemplary embodiment, and includes an open first end 114 defining a contact cavity or receptacle 116 that receives the contacts 112. Retaining features may be provided in the contact cavity 116 to secure the contacts 112 within the receptacle 116. The housing 110 includes a second end 118 opposite the open first end 114, and the second end 118 is generally closed with two apertures (not shown) that receive stripped ends 120, 122 of the respective load wires 106, 107. A latch beam 124 is formed on a surface of the housing 110 adjacent the first end 114 for securing the male connector 102 to the female connector 104 (FIG. 1). While the housing 110 is illustrated as rectangular in an exemplary embodiment, it is appreciated that other geometric shapes of the housing 110 may likewise be used in alternative embodiments. Similarly, while a latch beam 124 is shown as connecting the male connector 102 with the female connector 104, it is appreciated that any other type of latching or mating feature can be used to join or mate the two connectors.

The contacts 112 are formed from a sheet of conductive material according to, for example, a known stamping and formation process. In an exemplary embodiment, the contacts 112 each include a contact blade 126 at one end, and a compliant contact section having a compliant contact beam 128 at a second end thereof that receives the respective wire stripped ends 120, 122 with poke-in connection in the illustrated embodiment. Deflectable latch tabs 130 are also provided in the contacts 112 that cooperate with locking protrusions or locking apertures in the housing receptacle 116 to secure and maintain the contacts 112 in a predetermined position within the housing 110. When the contacts 112 are loaded into the housing 110, the contact blades 126 are located within the contact receptacle 116 of the housing 110 as seen in FIG. 1, and are recessed or spaced from the housing first end 114.

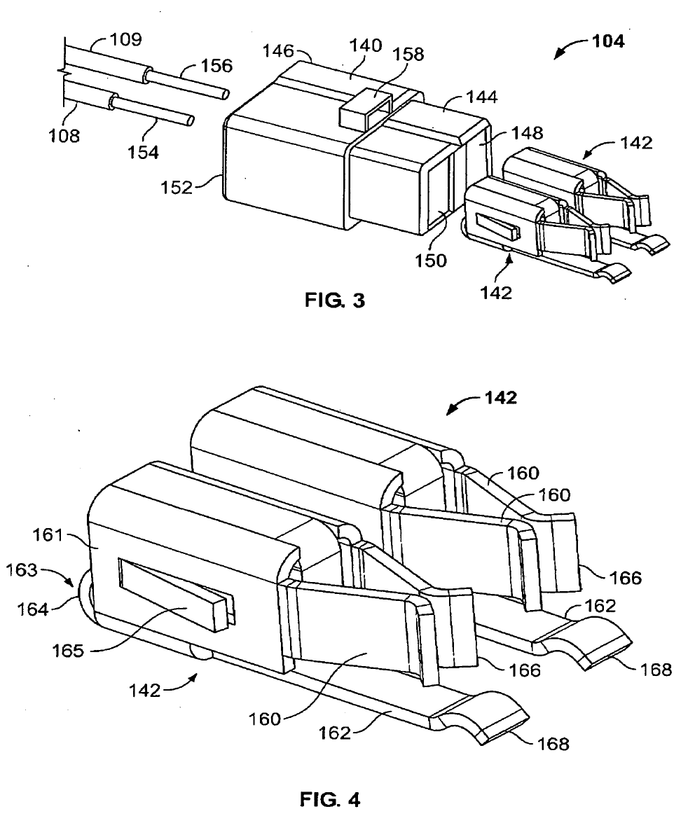

FIG. 3 is an exploded view of the female connector 104 including a housing 140 fabricated from a nonconductive or dielectric material, contacts 142 loadable into the housing 140, and connecting line wires 108, 109. The housing 140 is complementary in shape to the male connector housing 110 (FIG. 2), and includes a leading portion 144 extending from a main body 146 so that it can mate with the male connector 102. The leading portion 144 defines first and second contact receptacles 148, 150 and is of a slightly smaller outer dimension than the main body 146. Retaining features may be provided in the contact cavities 148, 150 and/or within the main body 146 to secure the contacts 142 within the receptacles 148, 150 and/or the main body 146.

An end 152 of the housing 140 opposite the leading portion 144 is generally closed or solid with two apertures (not shown) that receive stripped ends 154, 156 of the respective line wires 108, 109. A locking element 158 is formed on a surface of the housing main body 146 adjacent the leading portion 144. The locking element 158 receives the latch beam 124 (FIG. 2) of the male connector housing 110 when the male connector 102 and the female connector are engaged with one another.

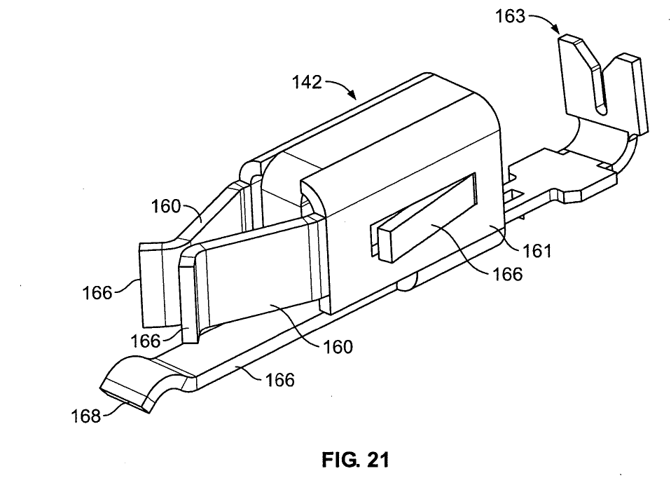

FIG. 4 is an enlarged view of the contacts 142 of the female connector 104. The contacts 142 are formed from a sheet of conductive material according to, for example, a known stamping and formation process. In an exemplary embodiment, the contacts 142 each include a pair of deflectable primary contact beams 160 extending axially from a contact body 161 in a vertical plane, and a single sacrificial leading contact beam 162 corresponding to each pair of primary contact beams 160 and extending in a horizontal plane substantially perpendicular to a plane of the primary contact beams 160. Termination sections 163 having, for example, compliant contact beams 164 are formed opposite the primary contact beams 160, and the contact beams 164 receive and retain the respective wire stripped ends 154, 156 (FIG. 3) with poke-in connection. Alternatively, the termination sections 163 may include a crimping contact section as shown in FIG. 20 for connection to the wires 108 and 109, or the termination section 163 may include an insulation displacement contact section to mechanically and electrical engage the wires 108 and 109 as shown in FIG. 21. Deflectable latch tabs 166 are also provided in the contacts 142 that cooperate with locking protrusions or locking apertures in the housing leading portion 144 and/or the housing main body 146 to secure and maintain the contacts 142 in a predetermined position within the female connector housing 140.

The primary contact beams 160 in each contact 142 extend obliquely from the contact body 161 and toward one another for a predetermined length, and distal ends 168 of the contact beams 160 are outwardly flared from one another. The leading contact beams also extend 162 also extend from the contact body 161, and more specifically extend axially and forwardly beyond the distal ends 168 of the primary contact beams 160 for a specified distance. Distal ends 168 of the leading contact beams 162 are rounded or raised at a location spaced from the distal ends 168 of the primary contact beams 160. When the contacts 142 are loaded into the housing 140, the distal ends 168 of the leading contact beams 162 are located within the respective contact receptacles 148, 150 of the housing leading portion 144 and are recessed or spaced from the distal end of the housing and the open end of the receptacles 148, 150. As such, the energized line contacts 142 are generally recessed within the housing 140 to prevent inadvertent operator contact with the energized contacts 142 when the male and female connectors are unplugged or disengaged.

In use, as the male connector 102 and the female connector are engaged or plugged, the distal ends 168 of the leading contact beams 162 establish electrical contact with the contact blades 126 (FIG. 2) of the male connector 102 before electrical contact is established with the primary contact beams 160. Thus, when the contacts 142 of the female connector 104 are energized and the electrical connection with the contacts 112 of the male connector 102 is completed, energy associated with the engagement of the contacts 142, 112 is discharged at the interface of the contact blades 126 and the leading contact beam distal ends 168 at a location away from the primary contact beams 160. Also, any residual damage that may occur from repeated plugging and unplugging of the male and female connectors 102, 104 under energized circuit conditions, including but not limited to fusion and debris, is experienced at the leading edge of the contact blades 126 and the distal ends 168 of the leading contact beams 162.

As the connectors 102, 104 continue to be engaged and moved toward one another, the contact blades 126 of the male connector 102 engage the distal ends 168 of the primary contact beams 160 until the primary contact beams 160 are deflected and the contact blades 126 are received between each respective pair of primary contact beams 160 in the female connector 104. The primary contact beams 160 define a contact area for engagement with the contact blades 126 apart from contact areas associated with the leading contact beam distal ends 168. The deflection of the primary contact beams 160 generates a normal force on the surface of the contact blades 126 to ensure mechanical and electrical engagement of the primary contact beams 160 and the contact blades 126 at a location unaffected by any damage to the leading edge of the contact blades 126, and a primary current path or contact area is established therebetween.

Likewise, as the male connector 102 and the female connector 104 are moved apart from one another to disengage or unplug the connector assembly 100, the contact blades .126 of the male connector 102 break electrical contact with the primary contact beams 160 before electrical contact is broken with distal ends 168 of the leading contact beams 162 in the female connector 104. Thus, energy associated with disengagement of the contacts 112, 142 under load is discharged at the interface of the contact blades 126 and the leading contact beam distal ends 168 at a location away from the primary contact beams 160. Accordingly, any residual damage that may occur from repeated plugging and unplugging of the male and female connectors 102, 104 under energized circuit conditions is experienced at the leading edge of the contact blades 126 and the distal ends 168 of the leading contact beams 162. In such a manner, the sacrificial leading contact beams 162 dissipate most of the energy and incur potential damage when the connectors 102, 104 are engaged and disengaged under load, while the primary contact beams 160 are protected for safe and reliable operation of the connectors 102, 104.

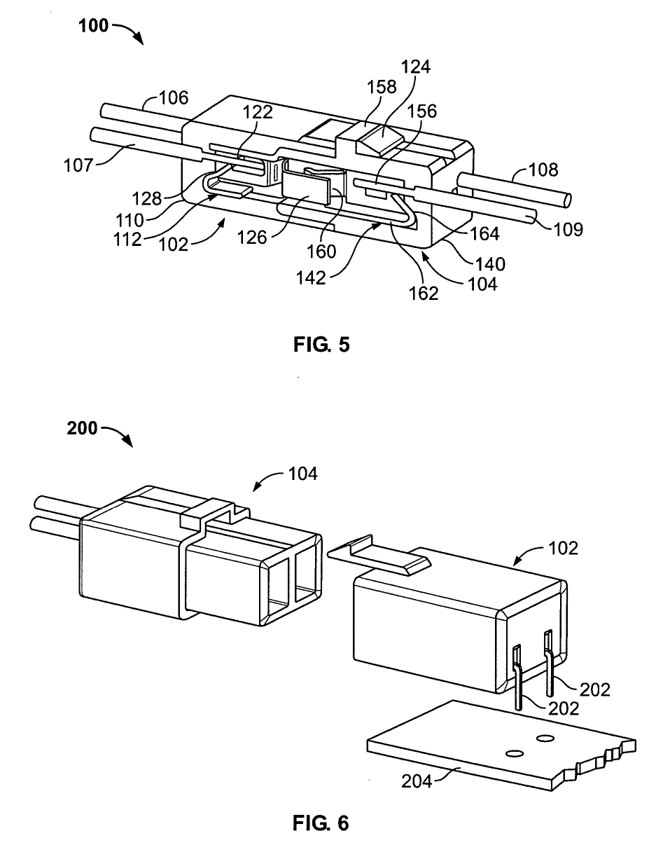

FIG. 5 is a sectional view of the connector assembly 100 in a plugged or mated position. The respective housings 110, 140 of the male and female connectors 102, 104 are mated or nested with one another wherein the leading portion 144 of the female connector housing 140 is fitted within the contact receptacle 116 of the male connector housing 110. The male connector latch beam 124 is engaged to and releasably locked with the locking element 158 to maintain the male and female connectors 102, 104 in the plugged or mated position when the connectors 102, 104 are fully engaged to one another. The contact blades 126 of the male connector 102 are seated between and in mechanical and electrical engagement with the primary contact beams 160 of the female connector 104. Any dissipation of energy as the connectors 102, 104 are engaged and disengaged under load is contained at a location interior to the male and female connectors 102 and 104.

As is also shown in FIG. 5, in one embodiment the stripped ends 122, 156 of the respective wires 107, 109 are engaged to and retained by the respective compliant beams 128, 164 of the contacts 112 and 142 with poke-in connection, although the wires 107, 109 could be otherwise terminated to the contacts 112 and 142, such as with known other termination sections including crimping or insulation displacement contact section techniques to mechanically and electrical engage the wires 107 and 109. The wires 106 and 108 are connected to the contacts 112 and 142 in a similar manner to the wires 107 and 109. By virtue of the above-described construction, the connector assembly 100 may capably complete and break an electrical connection while energized and under electrical load without damaging the primary contacts, and the connectors 102 and 104 are generally touch safe and avoid risk of electric shock by an operator (including but not limited to electricians, maintenance personnel or homeowners) in each of the plugged and unplugged positions.

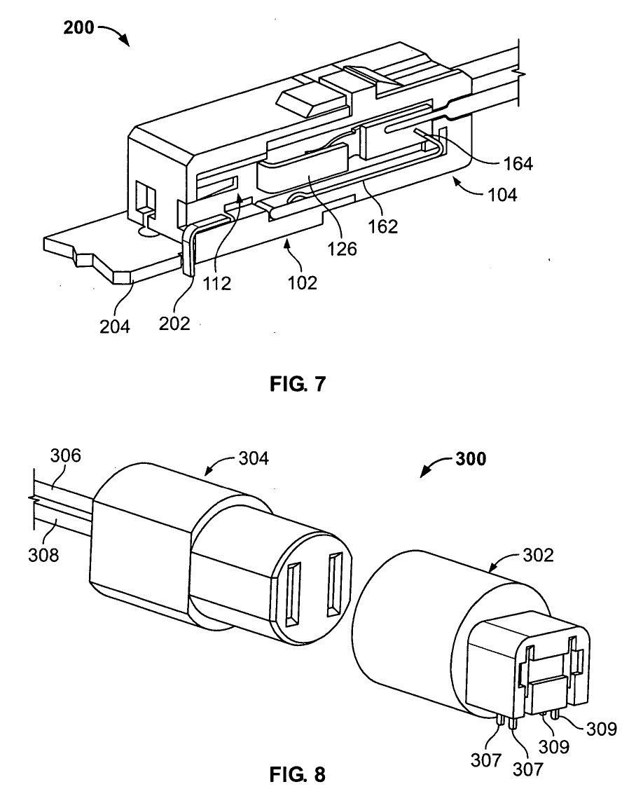

FIG. 6 and 7 are a perspective view and a sectional view, respectively, of a second embodiment of an exemplary connector assembly 200 in an unplugged or unmated position. The assembly 200 is similar to the assembly 100 is some aspects, and like reference characters of the assembly 100 are utilized in FIG. 5 to denote like features of the connector assembly 200.

The assembly 200 includes the female connector 104 and the male connector 102 substantially as described above, except that the male connector 102 includes contacts having right angle legs 202 so that the male connector 102 may be mounted to a circuit board 204 with known through-hole mounting techniques. The right angle legs 202 may be formed with the aforementioned contacts 112 via known stamping and formation techniques, and as shown in FIG. 7, the contact legs 202 are extended through the circuit board 204 to establish electrical connection therewith. The assembly 200 is otherwise constructed and operates substantially similar to the assembly 100 described above, and the assembly 100 accordingly provides similar benefits as the connector assembly 100.

FIG. 8 is a perspective view of a second embodiment of an exemplary connector assembly 300 in an unplugged or unmated position. The connector assembly 300 includes a male connector 302 and a female connector 304 interconnecting first and second load wires 306, 308 of the female connector 104 with respective right angle contact legs 307, 309 of the male connector 302. Like the assemblies described above, the connector assembly 300 permits poke-in connection of first and second wires 306, 308 that requires minimal time and effort to complete, although other termination methods may alternatively be employed, including but not limited to crimped terminations and insulation displacement contact techniques. Moreover, the connectors 302, 304 may be engaged and disengaged to reliably complete and break electrical interconnection of the wires 306 and 308 while the wires are energized and under electrical load. That is, the connector assembly 300 is operable without de-energizing associated circuitry.

It is appreciated that the connector assembly 300 can include contact legs with different configurations or designs to assure cable to board connection via the connector assembly 300. Alternatively, the male and female connectors 304 may be modified to connect, for example, first and second cables including respective line and load wires instead of interconnecting a cable and a circuit board.

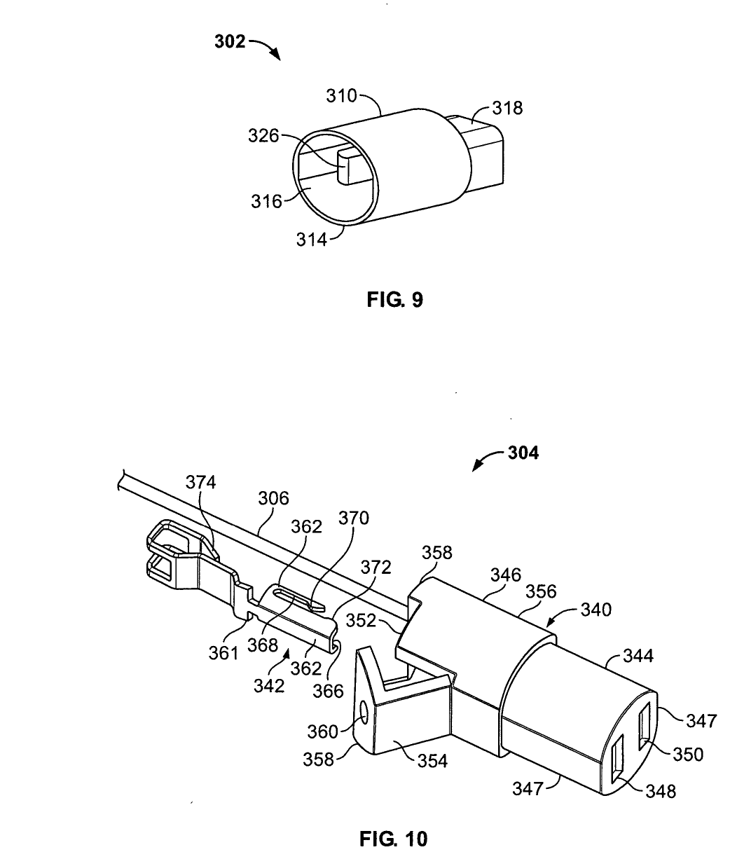

FIG. 9 is a partial exploded view of the male connector 302 including a housing 310 fabricated from a nonconductive or dielectric material, and contacts 312 loadable into the housing 310. The housing 310 is generally cylindrical in an exemplary embodiment, and includes an open first end 314 defining a contact cavity or receptacle 316 that receives the contacts 312. Retaining features may be provided in the contact cavity 316 to secure the contacts 312 within the receptacle 316. The housing 310 includes a generally rectangular second end 318 opposite the first end 314, and the second end 318 is generally closed or solid with two apertures (not shown) that receive the contacts 312. While the housing 310 is illustrated as generally cylindrical in an exemplary embodiment, it is appreciated that other geometric shapes of the housing 310 may likewise be used in alternative embodiments.

The contacts 312 are formed from a sheet of conductive material according to, for example, a known stamping and formation process. In an exemplary embodiment, the contacts 312 each include a contact blade 326 at one end, and the right angle legs 307 at an opposite end. The contacts 312 may be fitted in the second end 318 of the housing 310 with, for example, a force fit or interference fit. When the contacts 312 are loaded into the housing 310, the contact blades 326 are located within the contact receptacle 316 of the housing 310, and distal ends of the contact blades 326 are recessed or spaced from the housing first end 114. The contact legs 307 may be mounted to, for example, a circuit board.

FIG. 10 is a partial exploded view of the female connector 304 including a housing 340 fabricated from a nonconductive or dielectric material, contacts 342 (only one of which is visible in FIG. 10) loadable into the housing 340, and connecting line wires 306, 308 (only one of which is shown in FIG. 10). The housing 340 is complementary in shape to the male connector housing 310 (FIG. 9), and includes a leading portion 344 extending from a main body 346. In an exemplary embodiment, the outer surface of the leading portion 344 is generally cylindrical, but includes opposed generally flat surfaces 347 that cooperate with flat surfaces in the male connector contact receptacle 316 (FIG. 9) when the connectors 302, 304 are engaged. The flat surfaces 347 ensure proper engagement of the male and female connectors 302, 304 in use.

The leading portion 344 defines first and second contact receptacles 348, 350 and is of a slightly smaller outer dimension than the main body 346. Retaining features may be provided in the contact cavities 348, 350 and/or within the main body 346 to secure the contacts 342 within the receptacles 348, 350 and/or the main body 346.

An end 352 of the housing 340 opposite the leading portion 344 includes hinged covers 354, 356 that each include a generally closed or solid rear wall 358 with an aperture 360 therein that receives a stripped end of the respective line wires 306, 308 when the contacts 342 are loaded in the housing main body 346.

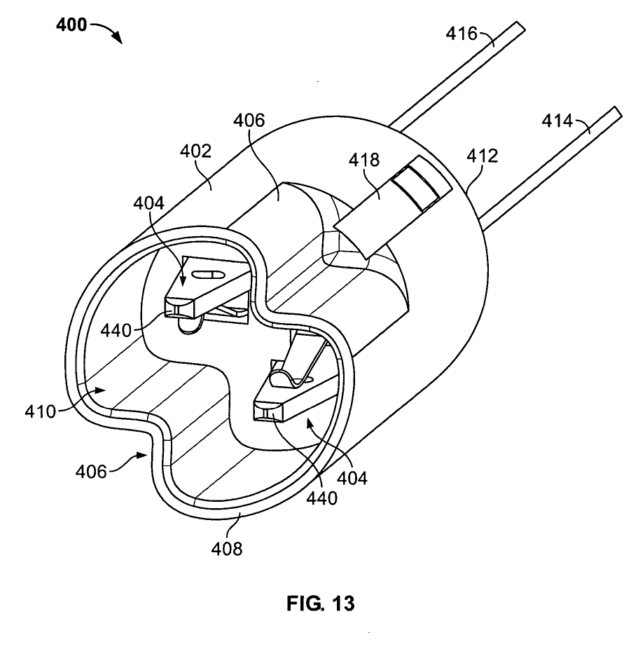

Referring to FIGS. 10 and 12, the contacts 342 are formed from a sheet of conductive material according to, for example, a known stamping and formation process. Preferably, the contacts 342 are stiff and rigid to resist bucking, bending, or column failure that might occur with contact welding under hot plugging conditions. In an exemplary embodiment, the contacts 342 each include a leading portion 362 extending axially from a contact body 361. The lead portion 362 includes a pair of deflectable primary contact beams 364 extending above a channel portion beam 366 defining for example, a U-shaped channel. The primary contact beams 364 are attached to the channel portion beam 366 at one thereof, and the primary contact beams 364 extend generally parallel to one another and to the channel portion beam 366, thereby defining a slot 368 between the primary contact beams 364 and upstanding legs of the channel portion beam 366. The slot 368 is dimensioned to accept one of the contact blades 326 (FIG. 9) of the male connector 102. A distal end of the primary contact beams 364 includes a rounded contact region 370 defining a contact area that projects into and partially obstructs the slot 368. When engaged by the contact blade 326, the rounded contact region 370 causes the primary contact beams 364 to deflect, and deflection of the beams 364 provides a normal force contact on the surface of the blade 326 to ensure mechanical and electrical engagement of the contact blade 326 and the primary contact beams 364. The configuration of the contacts 342 as illustrated provides for stiff and rigid contacts for greater durability, and while the contacts 342 are shown with a U-shape design, it is appreciated that other configurations and designs could be used in lieu of a U-shape to provide rigid and stiff contacts for greater durability.

A distal end of the channel portion beam 366 includes a sacrificial leading contact region having a rounded edge 372 projecting upwardly from the channel portion beam 366. Compliant contact sections including compliant beams 374 are formed in the contacts 342 opposite the leading portion 362, and the contact beams 374 receive and retain the respective a wire stripped ends 376 with, for example poke-in connection. Other known wire termination methods and techniques, however, may alternatively be employed in other embodiments.

The primary contact beams 364 in each contact 342 extend axially and parallel to one another for predetermined length, and a distal end of the channel portion beam 366 extends axially and forwardly beyond the distal ends of the primary contact beams 364 for a specified distance. When the contacts 342 are loaded into the housing 340 (FIG. 10), the distal end of the contact channel portion beam 366 is located within the respective contact receptacles 348, 350 of the housing leading portion 344 and are recessed or spaced from the distal end of the housing and the open end of the receptacles 348, 350. As such, the energized line contacts 342 are generally recessed within the housing 340 to prevent inadvertent operator contact with the energized contacts 342 when the male and female connectors are unplugged or disengaged.

In use, as the male connector 302 and the female connector 304 are engaged or plugged, the distal ends of the contact channel portion beams 366 establish electrical contact with the contact blades 326 (FIG. 9) of the male connector 302 before electrical contact is established with the primary contact beams 364. Preferably, there is one or more points of contact, thereby improving reliability of the connection. Thus, energy associated with making or breaking of the electrical connection under load is discharged at the interface of the contact blades 326 and the leading contact portions 366 at a location away from the primary contact beams 364. Also, any residual damage that may occur from repeated plugging and unplugging of the male and female connectors 302, 304 under energized circuit conditions is experienced at the leading edge of the contact blades 326 and the distal ends the leading contact channel portion beams 366.

As the connectors continue to be engaged and moved toward one another, the contact blades 326 engage the distal ends of the primary contact beams 364 until the primary contact beams 364 are deflected and the contact blades 326 are received in the slot 368. The deflection of the primary contact beams 364 generates a normal force on the surface of the contact blades 326 to ensure mechanical and electrical engagement of the primary contact beams 364 and the contact blades 326 at a location unaffected by any damage to the leading edge of the contact blades 326, and a primary current path is established therebetween. In such an embodiment, the side of the contact blade 326 that engages with the channel portion beam 366 is a sacrificial region, and the other side or surface of the blade 326 establishes primary contact with the beams 364 at a location unaffected by any damage or debris from the plugging and unplugging of the connectors 302 and 304.

Likewise, as the male connector 302 and the female connector 304 are moved apart from one another to disengage or unplug the connector assembly 300, the contact blades 326 break electrical contact with the primary contact beams 364 before electrical contact is broken with distal ends of the leading contact channel portion beams 366. Thus, energy is discharged at the interface of the contact blades 326 and the leading contact channel portion beams 366 at a location away from the primary contact beams 364, and any residual damage that may occur from repeated plugging and unplugging of the male and female connectors 302, 304 under energized circuit conditions is experienced at the leading edge of the contact blades 326 and the distal ends of the leading contact channel portion beams 362.

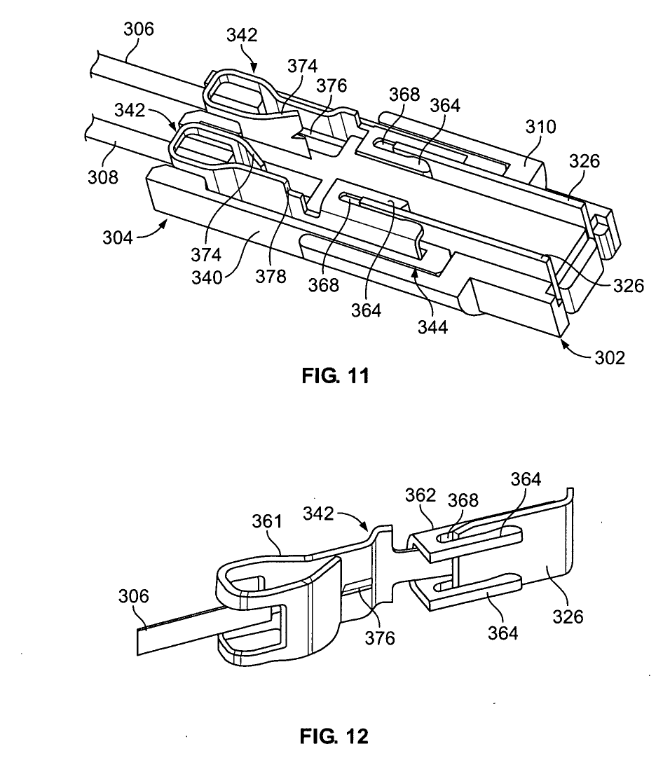

FIG. 11 is a sectional view of the connector assembly 100 in a plugged or mated position. The respective housings 310, 340 of the male and female connectors 302, 304 are mated or nested with one another wherein the leading portion 344 of the female connector housing 340 is fitted within the contact receptacle 316 of the male connector housing 310. The contact blades 326 of the male connector 302 are seated between and in mechanical and electrical engagement with the primary contact beams 364 of the female connector 104. Any dissipation of energy as the connectors 302, 304 are engaged and disengaged under electrical load is contained at a location interior to the male and female connectors 302 and 304.

As also shown in FIG. 11, the stripped ends 376, 378 of the respective wires 306, 308 are engaged to and retained by the respective compliant beams 374 of the contacts 342 with poke-in connection. By virtue of the above-described construction, the connector assembly 300 may capably complete and break an electrical connection while energized and under electrical load, and the connectors 302 and 304 are generally touch safe and avoid risk of electric shock by an operator in each of the plugged and unplugged positions.

The several embodiments of connector assemblies described herein are provided for illustrative purposes only to illustrate the inventive concepts, and it is understood that the inventive concepts could be extended to other types and configurations of electrical contacts and connectors. For example, hermaphroditic or self mating contacts and housings could be provided with sacrificial contact regions for dissipating energy and incurring damage from plugging and unplugging energized electrical connections as described above. Further, the connector housings could include hermaphroditic engagement surfaces and/or polarizing or keying features to further enhance the touch safe connector systems described above for hot plugging operation. For example, FIGS. 13-18 illustrate another hot pluggable connector system having such features.

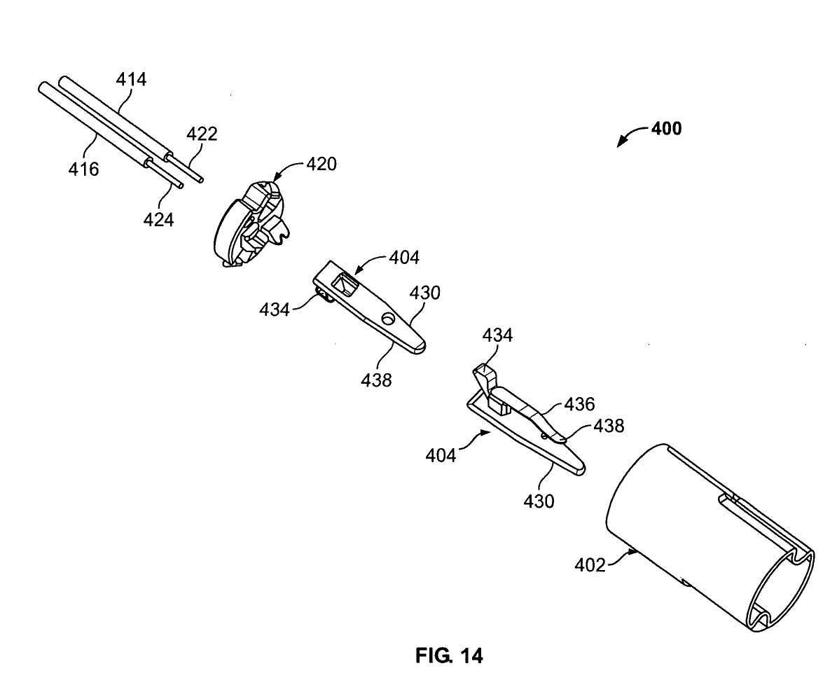

FIGS. 13 and 14 are an a perspective view and exploded view, respectively, of another embodiment of a male connector 400 for a hot pluggable connector system and interconnecting first and second load wires with first and second line wires in the manner explained below.

The male connector 400 including a housing 402 fabricated from a nonconductive or dielectric material, and contacts 404 loadable into the housing 402. The housing 402 is generally cylindrical in an exemplary embodiment, but includes recessed cutout sections 406 giving the housing 402 the general outline of a figure eight on an open first end 408. While the housing 402 is illustrated with one particular shape, it is appreciated that other geometric shapes of the housing 402 may likewise be used in alternative embodiments.

The open first end 408 defines a contact cavity or receptacle 410 that receives the contacts 404. Retaining features may be provided in the contact cavity 410 to secure the contacts 402 within the receptacle 410. The housing 402 includes a generally closed second end 412 opposite the first end 410, and the second end 412 includes two apertures (not shown) that receive load wires 414, 416. A latch element 418 is provided for mating engagement with a latch feature of a mating connector.

The contacts 404 are inverted relative to one another within the housing 402 as shown in FIGS. 13 and 14, and a contact piece 420 is provided to engage the contacts 404 and accept stripped ends 422, 424 of the wires 414, 416 to terminate the load wires 414, 416 to the respective contacts 404 with for example, poke-in connection, although it is appreciated that other termination techniques may be employed.

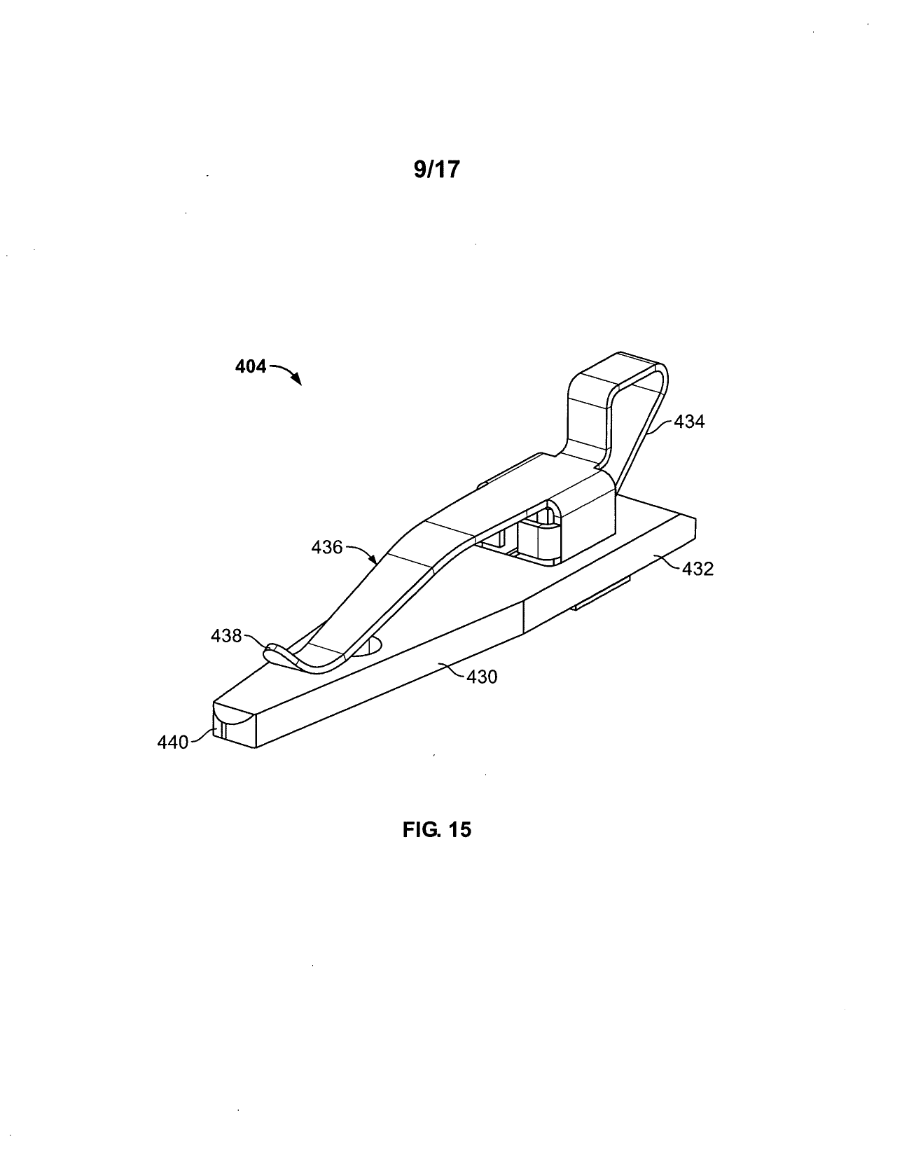

Referring to FIG. 15, each contact 404 is formed from a sheet of conductive material according to, for example, a known stamping and formation process. In an exemplary embodiment, the contacts 404 each include a tapered contact blade 430 extending axially from a contact body 432. A termination section 434 extends upwardly from the body 432 to engage and connect with the respective load wires 414, 416, and a compliant contact beam 436 having a rounded distal end 438 extends axially from the termination section 434 for a distance less than the distance which the contact blade 430 extends. Thus, a distal end 440 of the contact blade 430 extends beyond and is spaced from the distal end 438 of the contact beam 436.

When the contacts 404 are loaded into the housing 402, the contact blades 430 are located within the contact receptacle 410 of the housing 402, and distal ends 440 of the contact blades 430 are recessed or spaced from the housing first end 408. The contacts 404 are inverted or loaded into the housing 402 so that the contact beams 436 face in opposite directions as best shown in FIG. 14.

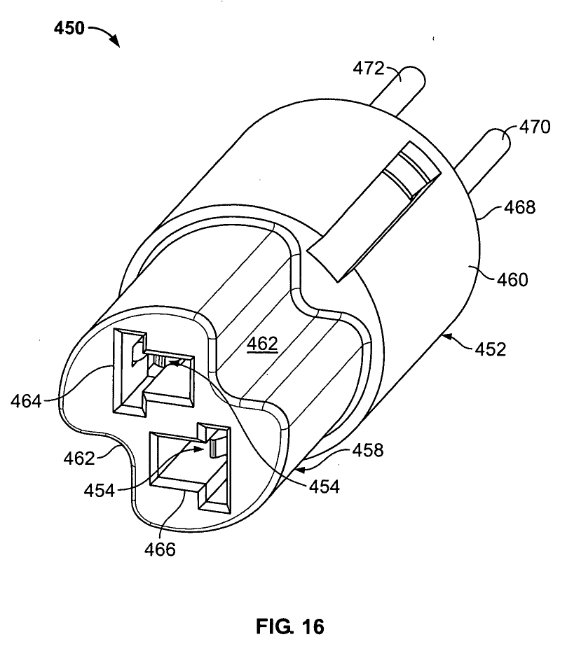

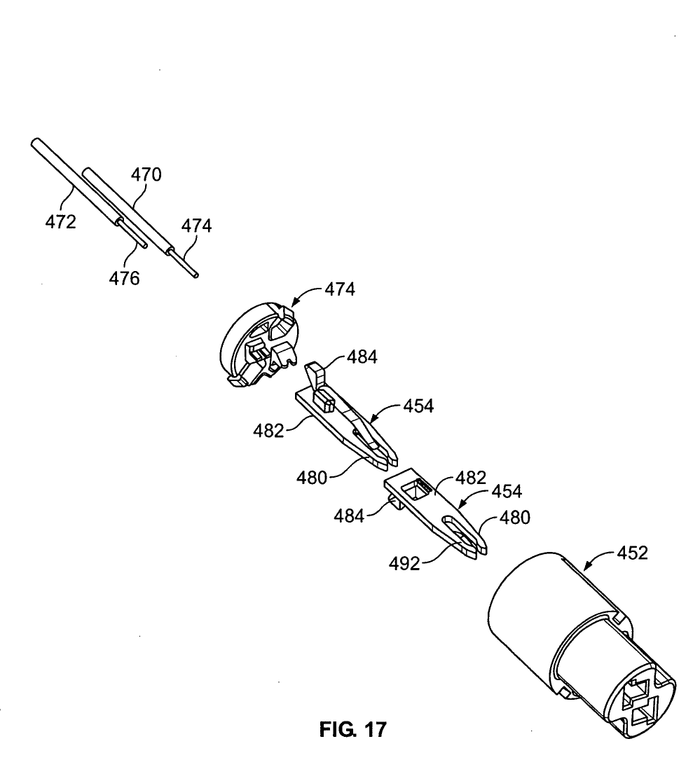

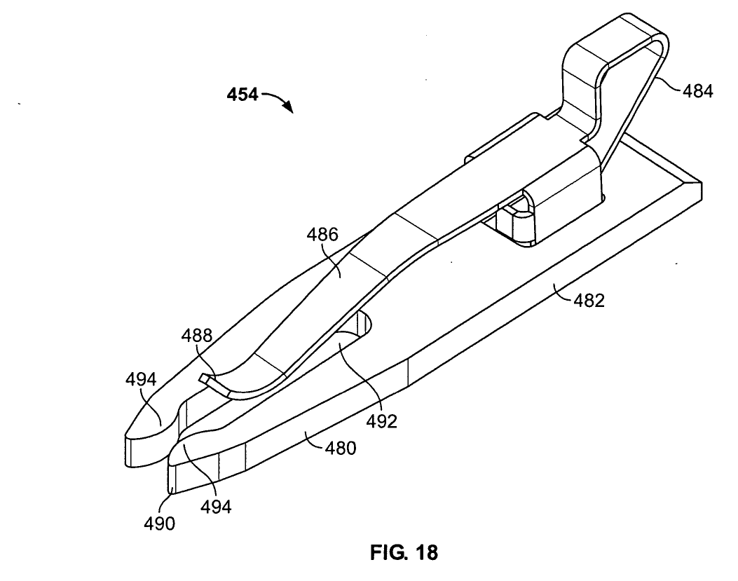

FIGS. 16 and 17 are a perspective and exploded view, respectively, of a female connector 450 that is matable with the male connector 400 described above. The female connector 450 includes a housing 452 fabricated from a nonconductive or dielectric material, contacts 454 loadable into the housing 452, and connecting line wires 454, 456. The housing 452 is complementary in shape to the male connector housing 402 (FIG. 13), and includes a leading portion 458 extending from a main body 460. In an exemplary embodiment, the outer surface of the leading portion 458 is generally cylindrical, but includes recesses or cutout areas 462, 464 that cooperate with the cutout areas 406 (FIG. 13) in the male connector housing 402 when the connectors 400, 450 are engaged. The cut out areas 462 ensure proper engagement of the male and female connectors 400, 450 in use, and provide polarizing engagement surfaces therebetween.

The leading portion 458 defines first and second contact receptacles 464, 466 and is of a slightly smaller outer dimension than the main body 460. Retaining features may be provided in the contact cavities 464, 466 and/or within the main body 458 to secure the contacts 454 within the receptacles 464, 466 and/or the main body 460. An end 468 of the housing 452 opposite the leading portion 458 includes is generally closed with respective apertures therein that receive stripped ends of respective line wires 470, 472 when the contacts 454 are loaded in the housing main body 460.

The contacts 454 are inverted relative to one another within the housing 452 as shown in FIGS. 16 and 17, and a contact piece 474 is provided to engage the contacts 454 and accept stripped ends 474, 476 of the wires 470, 472 to terminate the load wires 470, 472 to the respective contacts 454 with for example, poke-in connection, although it is appreciated that other termination techniques may be employed.

Referring to FIG. 18, each contact 454 is formed from a sheet of conductive material according to, for example, a known stamping and formation process. In an exemplary embodiment, the contacts 454 each include a tapered leading edge or beam 480 extending axially from a contact body 482. A termination section 484 extends upwardly from the body 482 to engage and connect with the respective load wires 470, 472, and a compliant or deflectable primary contact beam 486 having a rounded distal end 488 extends axially from the termination section 484 for a distance less than the distance which the leading edge 480 extends. Thus, a distal end 490 of the leading edge 480 extends beyond and is spaced from the distal end 488 of the primary contact beam 486.

When the contacts 454 are loaded into the housing 452, the leading edges 430 are located within the contact receptacles 464 and 466, and distal ends 490 of the leading edges 490 are recessed or spaced from the open edge of the receptacles 464 and 466. The contacts 454 are inverted or loaded into the housing 452 so that the primary contact beams 486 face in opposite directions as best shown in FIG. 17.

The leading edge 480 of each contact 454 is forked and defines a slot 492 that is dimensioned to accept the contact blade 430 (FIGS. 13 and 14) of the male connector 400. Sacrificial contact regions 494 extend inwardly from the distal end 490 and partially obstruct the slot 492 when the connectors 400 and 450 are engaged. The sacrificial contact regions 494 establish electrical contact with the male contact blades 430 before the contact beams 486 establish electrical connection with the contact blades 430 when the connectors 400, 450 are mated. Consequently, the sacrificial contact regions 494 dissipate most of the energy when the male and female connectors 400, 450 are plugged under electrical load conditions, and incur any incidental or residual damage from repeated hot plugging.

As the connectors 400, 450 continue to be engaged, the tapered side edges of the contact blades 430 engage and deflect the distal ends 488 of the primary contact beam 486, thereby establishing another contact area or point of electrical contact with the contact blades 430 at a location spaced from the sacrificial contact regions 494 and unaffected by dissipation of energy as the connectors 400, 450 are mated. Furthermore, deflection of the primary contact beams 486 generates normal force contact between the contact beam 488 and the respective tapered side edge of the contact blade 430. Because the contacts 454 are inverted in the female housing 452, the primary contact beams 486 are deflected in opposite directions when the connectors are mated. Also, in an exemplary embodiment, the contact beams 436 (FIGS. 14 and 15) are also deflected by the side edges of the of the leading contact beams 480, thereby providing another contact area between the mating contacts 404, 454 and an additional normal contact force to ensure electrical connection.

When the connectors 400, 450 are unplugged or disengaged from one another, the tapered side edges of the contact blades 430 disengage from the distal ends 488 of the primary contact beams 486 before the sacrificial regions 494 disengage the contact blades 430. Consequently, the sacrificial contact regions 494 dissipate most of the energy when the male and female connectors 400, 450 are unplugged under electrical load conditions, and incur any incidental or residual damage from repeated hot plugging at a location away from the primary contact beams 486.

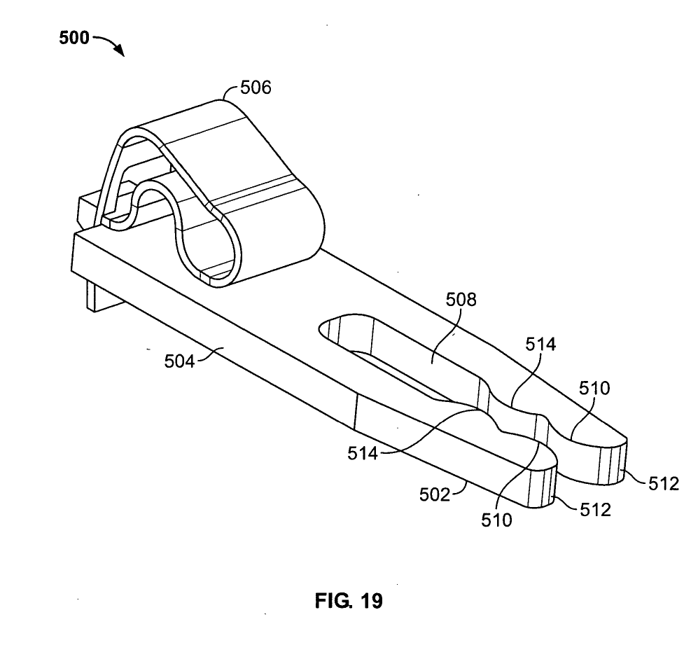

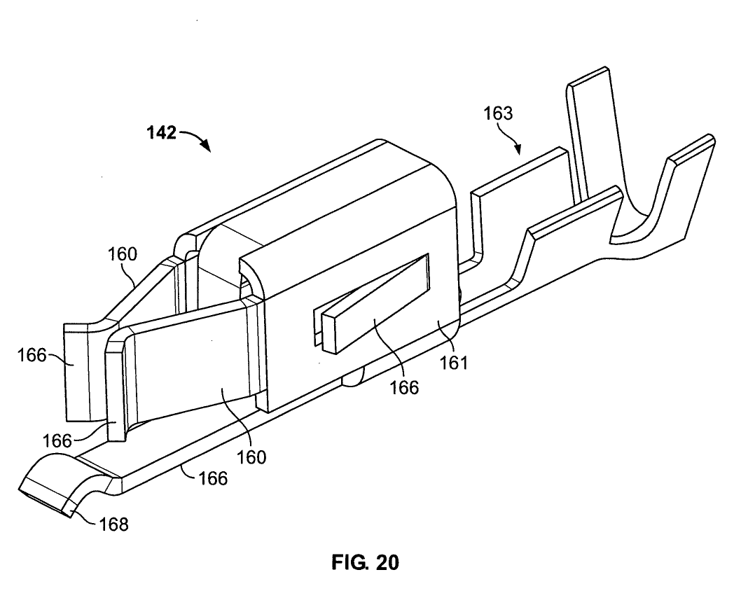

FIG. 19 is a perspective view of an alternative contact 500 that may be used in lieu of the contacts 454 in the female connector 450 described above.

As shown in FIG. 19, the contact 500 is formed from a sheet of conductive material according to, for example, a known stamping and formation process. In an exemplary embodiment, the contact 500 includes a tapered edge 502 extending axially from a contact body 504. A termination section 506 in the form of a known spring clamp terminal extends upwardly from the body 504 to engage and connect with a load wires in a known manner.

The leading edge 502 of the contact 500 is forked and defines a slot 508 that is dimensioned to accept the contact blade 430 (FIGS. 13 and 14) of the male connector 400. Sacrificial contact areas or regions 510 extend inwardly from the distal ends 512 and partially obstruct the slot 508. Primary contact areas or regions 514 also extend inwardly from the leading edge 502 and are located at a first axial distance from the contact body 504 that is less than the axial distance that the sacrificial regions 510 are located from the contact body 504. That is, the sacrificial regions 510 are spaced from the primary contact regions 514, and the sacrificial regions 510 are located closer to the distal end 512 of the leading edge 502 than are the primary contact regions 514.

Consequently, the sacrificial contact regions 510 establish electrical contact with the male contact blade 430 before the primary contact regions 514 establish electrical connection with the contact blade 430 when the male and female connectors are engaged. Consequently, the sacrificial contact regions 510 dissipate most of the energy when the male and female connectors are plugged under electrical load conditions, and incur any incidental or residual damage from repeated hot plugging.

As the connectors continue to be engaged, the contact blade 430 establishes electrical connection with the primary contact regions 514, thereby establishing another point of electrical contact with the contact blades 430 at a location spaced from the sacrificial contact regions 510 and unaffected by dissipation of energy as the connectors are mated.

Likewise, when the connectors are unplugged or disengaged from one another, the contact blade 430 disengages from the primary contact regions 514 before the sacrificial regions 510 disengage the contact blade 430. Consequently, the sacrificial contact regions 510 dissipate most of the energy when the male and female connectors are unplugged under electrical load conditions, and incur any incidental or residual damage from repeated hot plugging at a location away from the primary contact regions 514.

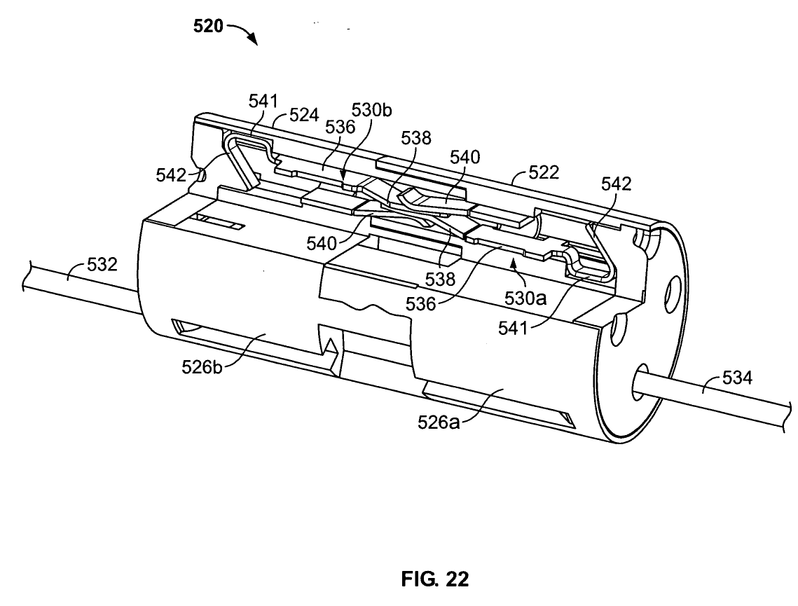

FIG. 22 illustrates another embodiment of a hot pluggable connector system 520 including twohermaphroditic connectors 522 and 524 each having a respective housing 526a, 526b and hermaphroditic contacts 530a, 530b situated therein for interconnecting load wires 532 and line wires 534 corresponding to the respective contacts 530a, 530b within the connectors 522, 524.

Each contact 530a, 530b includes a contact body 536, a leading contact beam 538 extending from the body 536, and a primary contact beam 540 formed with and extending from the body 536. Termination sections 541 also extend from the contact bodies 536, and in an exemplary embodiment the termination sections 541 include compliant contact beams 542 that receive and retain respective line and load wires with poke-in connection. In an exemplary embodiment, the contacts 530 are reversed and inverted with respect to one another in the respective housings 526a, 526b. That is, for each pair of mating contacts 530a, 530b in the respective housings 526a, 526b, the termination sections 541 face in opposite directions along a longitudinal axis of the connector housings 526, 528, and the primary contact beams 540 face in opposite directions extending transversely to the longitudinal axis.

Distal ends of the contact beams 540 are spaced from the contact body 536 by an axial length that is less than the spacing of the distal ends of the leading contact beams 538 from the contact bodies 536. Consequently, when the connectors 522, 524 are mated with one another, distal ends of the leading contact beams 538 of the respective contacts 530a, 530b establish electrical connection with one another before establishing electrical connection with the primary contact beams 540. The leading contact beams 538 accordingly define a sacrificial contact area that dissipates most of the energy associated with mating of the contact under load and incurs and residual damage from repeated hot plugging of the connectors. The leading contact beams 538 slidably engage one another as the connectors 522, 524 are mated.

As the connectors 522, 524 continue to be mated, the primary contact beams 540 or each contact 530a, 530b mechanically and electrically engages the leading contact beam 538 of the other contact 530a, 530b. As such, the primary contact beams 540 define a primary contact area that mechanically and electrically engages the respective leading contact beams 538 of the mating contacts. The primary contact beams 540 establish such electrical connection at a location spaced from the sacrificial contact area of the leading contact beams 538 and substantially unaffected by dissipation of energy as the connectors are plugged under electrical load. When fully engaged, and as shown in FIG. 22, the leading contact beams 538 of the mating contacts 530a, 530b engage one another in a face-to-face manner, and the leading contact beams 538 are sandwiched between the primary contact beams 540 for a secure mechanical and electrical connection. The primary contact beams 540 are deflected as the contacts are mated to produce a normal contact force and ensure mechanical and electrical engagement of the primary contact beams 540 and the leading contact beams 538.

When the connectors 522, 524 are unplugged, the primary contact beams 540 disengage the leading contact beam 538 of the mating contact before the leading contact beams 538 disengage from one another. Thus dissipation of energy as the energized electrical connection is broken is dissipated in the sacrificial areas of the leading contact beams 538 and not at the primary contact areas of the primary contact beams 540. Reliable hot plugging and unplugging is therefore ensured. Like the foregoing embodiments, the connectors 522, 524 are touch safe in each of the plugged and positions to protect electricians, maintenance personnel or homeowners from electric shock or hazard during hot plugging and unplugging.

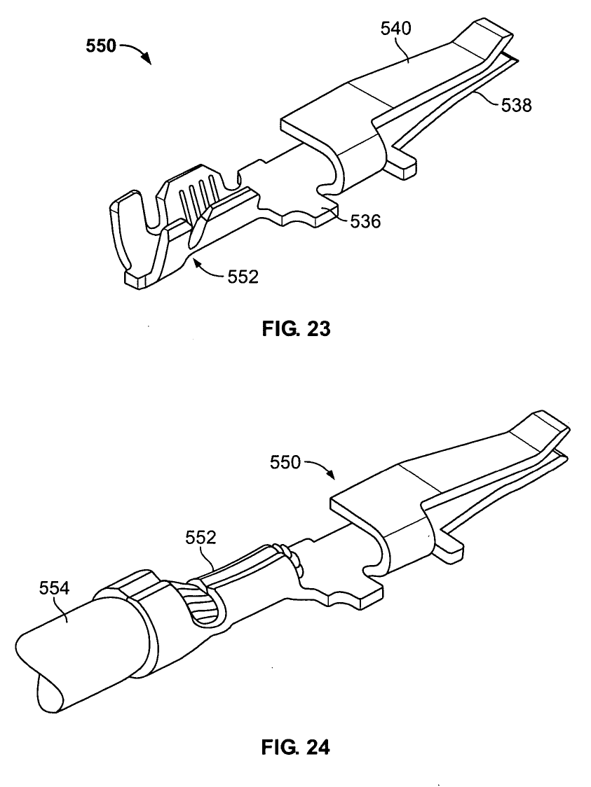

FIG. 23 illustrates an alternative contact 550 that is similar to the contacts 530a, 530b described above, except the contact 550 includes a termination section 552 configured for crimping to a wire 544 as shown in FIG. 24.

While the invention has been described in terms of various specific embodiments, those skilled in the art will recognize that the invention can be practiced with modification within the spirit and scope of the claims.

1-9. (canceled)

10. A connector assembly comprising:
a first connector comprising a housing and a first contact therein;
a second connector matable with the first connector, the second connector comprising a housing and a second contact therein;
wherein the first contact comprises a wire termination section, a primary contact area spaced from the wire termination section, and a leading contact beam spaced from the primary contact area; and
wherein, as the first and second connectors are mated, the second contact has a common portion that first establishes electrical connection with the leading contact beam of the first contact and thereafter establishes electrical connection with the primary contact area of the first contact.

11. The assembly of claim 10, wherein one of the first and second contacts is a right angle contact.

12. The assembly of claim 10, wherein the first contact comprises a pair of primary contact beams defining the primary contact area and the second contact comprises a contact blade, the contact blade being received between the pair of primary contact beams when the first and second connectors are mated.

13. The assembly of claim 10, wherein the primary contact area is defined on a contact beam extending in a first plane and the leading contact beam extends in a second plane, the first and second planes being substantially perpendicular.

14. The assembly of claim 10, wherein the leading contact beam defines a channel at a distal end of the second contact.

15. A connector assembly comprising:
a first connector comprising a housing and a first contact therein;
a second connector matable with the first connector, the second connector comprising a housing and a second contact therein;
wherein the first contact comprises a wire termination section, a primary contact area spaced from the wire termination section, and a leading contact beam spaced from the primary contact area, wherein the primary contact area is defined on a primary contact beam, the leading contact beam and the primary contact beam defining a slot therebetween, the slot dimensioned to receive the second contact; and
wherein the second contact establishes electrical connection with the leading contact beam of the first contact before establishing electrical connection with the primary contact area of the first contact when the connectors are mated.

16. The assembly of claim 10, wherein the primary contact area is defined on a first primary contact beam and a second primary contact beam, the first and second primary contact beams extending substantially parallel to one another.

17. The assembly of claim 10, wherein the first contact is configured for completing and breaking an energized electrical connection with the second contact at an end of the leading contact beam and in a location spaced from the primary contact area

18. The assembly of claim 10, wherein one of the first and second contacts is enclosed in the respective first or second housing when the first and second connectors are disengaged, thereby avoiding exposure of energized contact portions and protecting an operator from inadvertent contact therewith.

19. A connector assembly comprising:
a first connector comprising a housing and a first contact therein;
a second connector matable with the first connector, the second connector comprising a housing and a second contact therein;
wherein the first contact comprises a wire termination section, a primary contact area spaced from the wire termination section, and a leading contact beam spaced from the primary contact area, wherein the leading contact beam defines a slot, the primary contact area partially obstructing said slot; and
wherein the second contact establishes electrical connection with the leading contact beam of the first contact before establishing electrical connection with the primary contact area of the first contact when the connectors are mated.

20. The assembly of claim 10, wherein the leading contact beam defines a slot dimensioned to receive a mating contact, the second contact further comprising a deflectable contact beam extending adjacent said slot and defining said primary contact area.

21. A connector assembly comprising:
a first connector comprising a housing and a first contact therein, the first contact comprising a wire termination section, a primary contact beam and a leading contact beam configured to complete and break an energized electrical connection;
a second connector matable with the first connector in plugged and unplugged positions, the second connector comprising a housing and a second contact having a contact blade therein, wherein the contact blade extends in a first plane and the leading contact beam extends in a second plane, the first and second planes being substantially perpendicular; and
wherein, when the first and second connectors are mated, the contact blade establishes electrical connection with the leading contact beam at an end thereof and at a location spaced from the primary contact beam before being received by and establishing electrical connection with primary contact beam.

22. The assembly of claim 21, wherein one of the first and second contacts is a right angle contact.

23. (canceled)

24. The assembly of claim 21, wherein the leading contact beam and the primary contact beam define a slot therebetween, the slot dimensioned to receive the second contact.

25. The assembly of claim 21, wherein one of the first and second contacts is enclosed in the respective first or second housing when the first and second connectors are disengaged, thereby avoiding exposure of energized contact portions and protecting an operator from inadvertent contact therewith.

26. The assembly of claim 21, wherein the leading contact beam defines a U-shaped channel.

27. The assembly of claim 21, wherein the primary contact beam comprises a pair of primary contact beams.
